(19) United States
(12) Patent Application Publication
(10) Pub. No.: US 2026/0133384 A1
(43) Pub. Date: May 14, 2026

(54) EDGE TO GRATING OPTICAL COUPLING FOR A PHOTONIC INTEGRATED CIRCUIT BASED ASSEMBLY

(71) Applicant: CISCO TECHNOLOGY, INC., San Jose, CA (US)

(72) Inventors: Norbert SCHLEPPLE, Macungie, PA (US); Mark A. WEBSTER, Bethlehem, PA (US); Eng Wen ONG, Coopersburg, PA (US)

(21) Appl. No.: 18/946,066

(22) Filed: Nov. 13, 2024

(51) Int. Cl. G02B 6/42

(52) U.S. Cl. CPC G02B 6/4215; G02B 6/4213; G02B 6/423

(57) ABSTRACT

In one embodiment, an optoelectronic assembly includes at least one grating coupler and at least one edge coupler in contact with and optically coupled to the at least one grating coupler. The optoelectronic assembly may also include a primary photonic integrated circuit (PIC) to secondary PIC interface using the edge coupler and grating coupler, or edge-to-grating optical coupling.

### TECHNICAL FIELD

The present disclosure relates generally to optical systems, and more particularly to optical couplings for use in photonic integrated circuits.

### BACKGROUND

The statements in this section merely provide background information related to the present disclosure and may not constitute prior art.

Silicon photonics provide the ability to transfer large amounts of data with relatively small packaging in optical fiber networks. Coupling light to and from silicon photonic components can be challenging due to the large size mismatch between optical fibers and silicon photonic components. Currently, two primary and independent coupling techniques are employed, namely, edge coupling and surface coupling (also referred to as grating coupling). With edge coupling, light is coupled from lateral sides and is propagated in a common plane. Edge coupling has the advantages of high bandwidth and polarization insensitivity, however, mechanical and physical constraints exist due to the inherent mounting in a common plane, or along the edge. On the other hand, grating coupling involves extracting light from an optical waveguide, which scatters incoming light and can be configured to match the waveguide mode to a propagation mode of the incoming light. While grating coupling has the advantage of mechanical integrity of a large contact area, the ability to accommodate 2D coupling arrays, and less sensitivity to bowing of photonic integrated circuits (PICs), this approach has limitations relative to spectral bandwidth and polarization diversity.

The present disclosure addresses these challenges related to coupling of optical fibers with silicon photonics.

### BRIEF DESCRIPTION OF THE DRAWINGS

In order that the disclosure may be well understood, there will now be described various forms thereof, given by way of example, reference being made to the accompanying drawings, in which:

FIG. 1A is a side schematic view of an optoelectronic assembly in accordance with various embodiments of the present disclosure;

FIG. 1B is an enlarged detail view of an edge-to-grating optical coupling from FIG. 1A;

FIG. 2A is a side view of an edge-to-grating optical coupling in accordance with various embodiments of the present disclosure;

FIG. 2B is a perspective view of the edge-to-grating optical coupling of FIG. 2A;

FIG. 3A is a perspective view illustrating an interface between an edge coupler and a grating coupler in accordance with various embodiments of the present disclosure;

FIG. 3B is a perspective view illustrating another interface between an edge coupler and a grating coupler in accordance with various embodiments of the present disclosure;

FIG. 4A is a side schematic view of another optoelectronic assembly in accordance with various embodiments of the present disclosure;

FIG. 4B is a top view of the optoelectronic assembly of FIG. 4A;

FIG. 4C is a front view of the optoelectronic assembly of FIG. 4A;

FIG. 5 is a front view of another embodiment of an optoelectronic assembly in accordance with the present disclosure;

FIG. 6A is an enlarged perspective view of a photonic integrated circuit (PIC) having alignment features in accordance with various embodiments of the present disclosure;

FIG. 6B is an enlarged perspective view of a primary PIC and a secondary PIC having alignment features in accordance with various embodiments of the present disclosure;

FIG. 6C is an enlarged perspective view of a secondary PIC having alignment features in accordance with various embodiments of the present disclosure;

FIG. 7A is a front schematic view of an electrical connection between a primary PIC and a secondary PIC in accordance with various embodiments of the present disclosure;

FIG. 7B is a side schematic view of electrical connections between a primary PIC and a secondary PIC in accordance with various embodiments of the present disclosure;

The drawings described herein are for illustration purposes only and are not intended to limit the scope of the present disclosure in any way.

### DESCRIPTION OF EXAMPLE EMBODIMENTS

The following description is merely exemplary in nature and is not intended to limit the present disclosure, application, or uses. It should be understood that throughout the drawings, corresponding reference numerals indicate like or corresponding parts and features.

### Overview

As will be discussed in more detail herein, an optoelectronic assembly is provided that combines the advantages of both grating couplers and edge couplers in a single coupling arrangement. The coupling arrangement may be between two photonic integrated circuits (PICs), among other photonics components. In various embodiments, alignment features may be provided and the couplers may be configured to transmit in either transverse electrical or transverse magnetic optical modes. A variety of fiber types may be employed, including single mode fiber (SMF), polarization-maintaining fiber (PMF), reduced cladding (RC) fiber, and multicore fiber (MCF), and one of the PICs may include a plurality of polarization splitters, among other optical components. These and other embodiments of the innovative coupling arrangement of the present disclosure are set forth in greater detail below.

### Example Embodiments

Different couplings for optical fibers are available that each have advantages and disadvantages as set forth above. Accordingly, it is desirable to provide improved couplings for optical fibers in silicon photonics. Furthermore, other desirable features and characteristics of the present disclosure will become apparent from the subsequent detailed description and the appended claims, taken in conjunction with the accompanying drawings and the foregoing technical field and background.

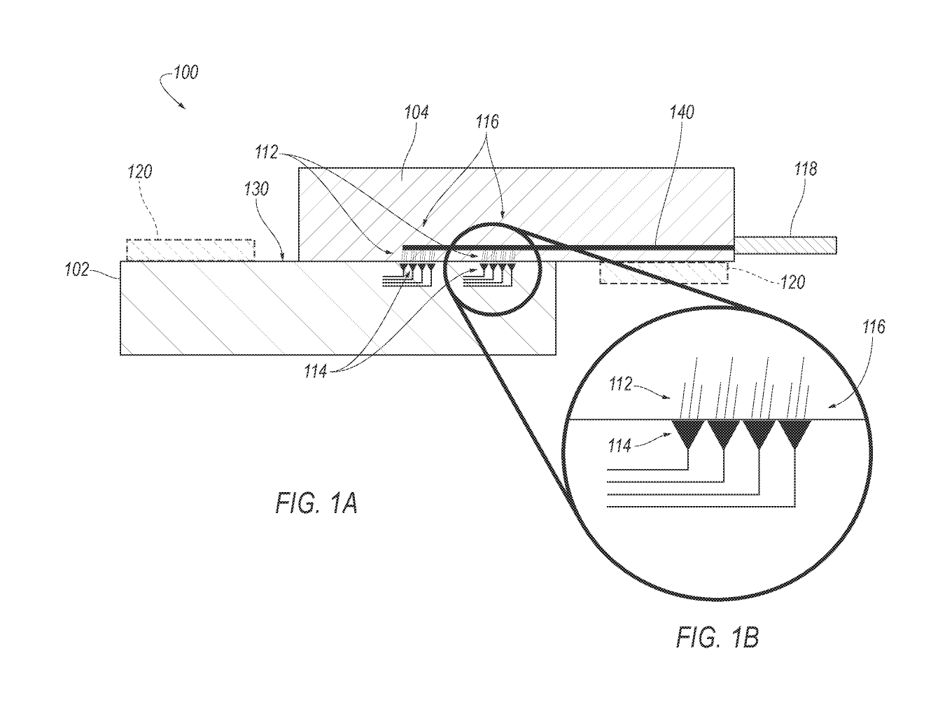

Referring to FIGS. 1A - 1B and 2A - 2B, an optoelectronic assembly is illustrated and generally indicated by reference numeral 100. In this exemplary embodiment, the optoelectronic assembly 100 includes a primary photonic integrated circuit (PIC) 102 coupled to a secondary PIC 104. More specifically, the primary PIC 102 and secondary PIC 104 are coupled by at least one at least one edge coupler 112 (two sets of four shown by way of example) in contact with and optically coupled to at least one grating coupler 114 (corresponding two sets of four shown in this example embodiment). The edge coupler 112 in contact with and optically coupled to the grating coupler 114 is referred to herein as an edge-to-grating optical coupling 116. As set forth in greater detail below, the edge-to-grating optical coupling 116 may be employed to couple other photonic components (e.g., fiber array units) and thus the illustration of the primary PIC 102 and secondary PIC 104 should not be construed as limiting the scope of the present disclosure. Further, the illustration of two sets of four edge couplers 112 and grating couplers 114 is merely exemplary and should not be construed as limiting the scope of the present disclosure.

As further shown, an optical circuit 140 extends from optical fiber(s) 118 to the edge-to-grating optical coupler 116. In this manner, tight fiber bending for surface coupling is eliminated. The optical circuit 140 is illustrated and described in greater detail below.

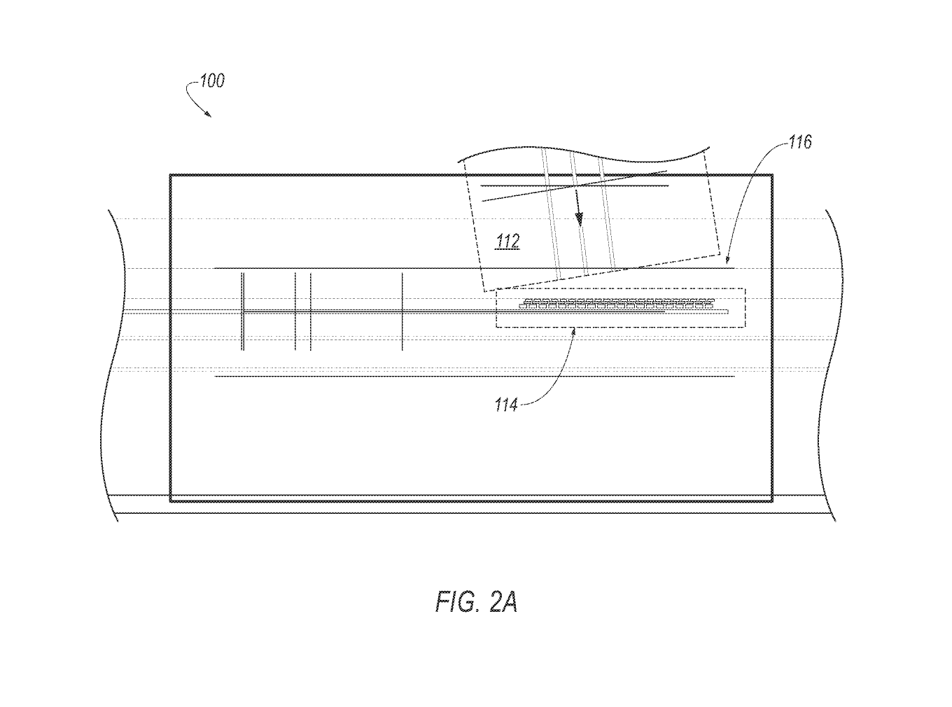

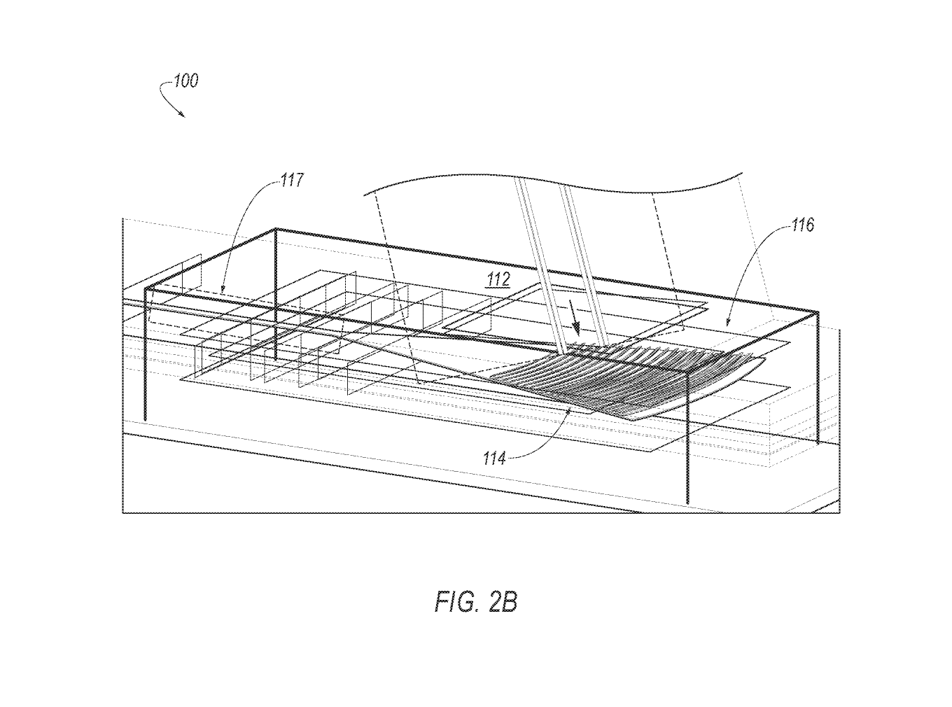

The primary PIC 102 and the secondary PIC 104 can be any semiconductor material that includes optical components such as waveguides 117 (FIGS. 2A - 2B), optical modulators, and optical detectors, among others. The optical components can be disposed or formed in an active surface layer of the primary PIC 102 and/or the secondary PIC 104.

In this embodiment, at least one optical fiber 118 is shown aligned with an edge of the primary PIC 102 and thus provides an input signal to the optoelectronic assembly 100. As set forth in greater detail below, fiber array units (FAUs) are employed in another embodiment, and thus the illustration of the optical fiber 118 is merely exemplary to illustrate signal communications using the innovative edge-to-grating optical coupling 116 of the present disclosure. As further shown, optional electronic integrated circuits (EICs) 120 may be employed in one or both of the primary PIC 102 and secondary PIC 104. Although only two EICs 120 are shown, any number of EICs 120 as well as other components may be implemented while remaining within the scope of the present disclosure.

As further shown, the primary PIC 102 defines an exterior surface 130, and the grating couplers 114 are mounted and exposed to the exterior surface 130 of the primary PIC 102. The secondary PIC 104 is also mounted to the exterior surface 130 of the primary PIC 102 as shown. As such, the edge couplers 112 are in contact with and optically coupled to the grating couplers 114, thereby forming the edge-to-grating optical couplings 116, further application of which is set forth in greater detail below.

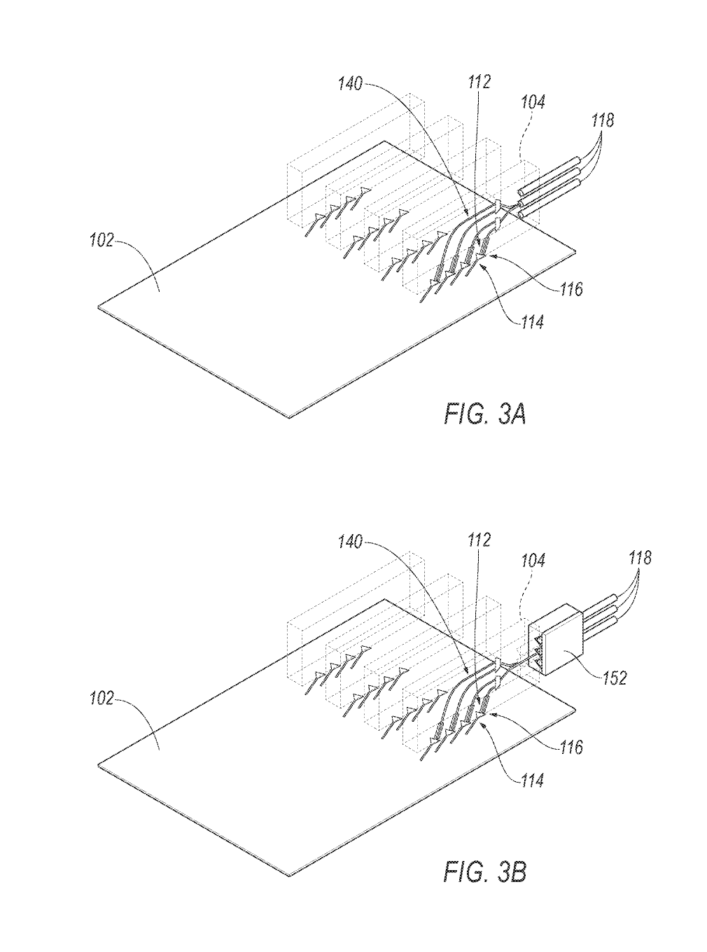

Referring now to FIGS. 3A and 3B, further details of the interface between the edge coupler 112 and the grating coupler 114 are shown. More specifically, optical circuits 140 extend from each optical fiber 118 to the edge-to-grating optical coupler 116. As shown in FIG. 3A, the optical fibers 150 may be attached passively through the edge of the secondary PIC 104 (or through an FAU as described in greater detail below). As shown in FIG. 3B, the optical fibers 150 may be attached actively with a fiber array unit 152 (which is also described in greater detail below). Only three optical fibers 118 are illustrated with only one optical fiber 118 shown routed with the optical circuits 140 for purposes of clarity. It should be understood that any number of fibers and routings may be employed while remaining within the scope of the present disclosure. Further, additional embedded components may be employed within the secondary PIC 104, which are described in greater detail below. As for the interface between the edge coupler 112 and the grating coupler 114, in one embodiment, the edge coupler 112 is diced (blade or stealth), and is bonded to a polished exterior surface 130 of the primary PIC 102.

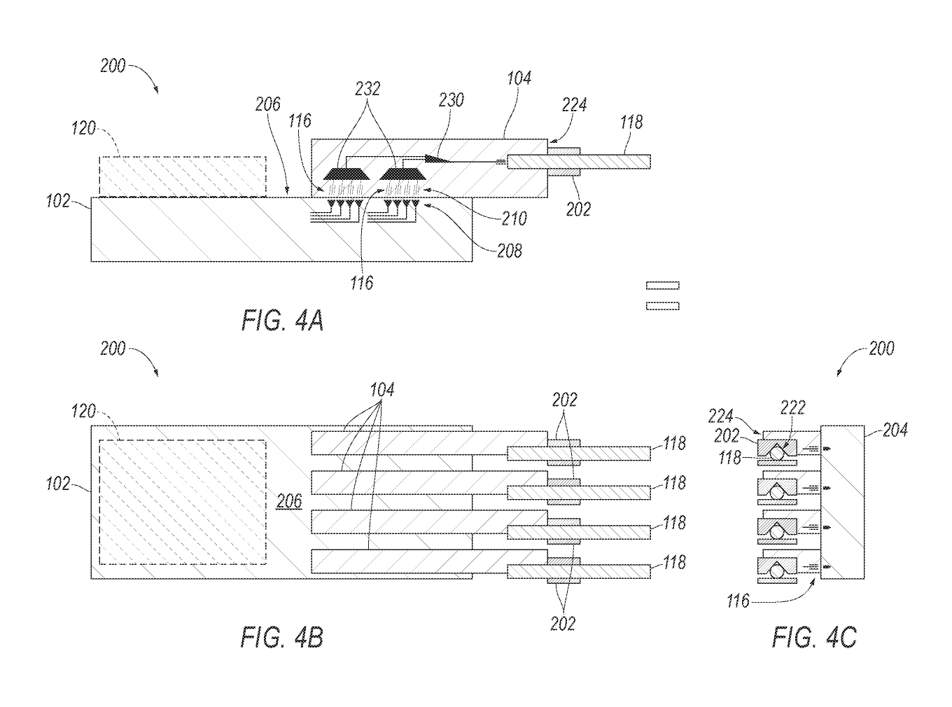

Referring now to FIGS. 4A - 4C, another form of an optoelectronic assembly is illustrated and generally indicated by reference numeral 200. In this embodiment, the primary PIC 102 is coupled to the secondary PIC 104 as set forth above, and a fiber array unit (FAU) 202 is coupled to the edge of the secondary PIC 104 as shown. Similar to previous embodiments, the primary PIC 102 defines an external surface 206, and at least one grating coupler 208 (two sets of four grating couplers 208 are illustrated by way of example) is mounted and exposed to the exterior surface 206 as shown. The secondary PIC 104 is mounted to the exterior surface 206 of the PIC 204, and the secondary PIC 104 includes at least one edge coupler 210 (a corresponding two sets of four edge couplers 210 are illustrated in this example) in contact with and optically coupled to the at least one grating coupler 208 of the PIC 102.

A plurality of optical fibers 118 are aligned within the FAU 202, using for example, v-grooves 222 as shown. The v-grooves 222 are mounted to a side 224 of the FAU 202 and are configured to actively align the plurality of optical fibers 118. The optical fibers 118 may be any in number and type, such as by way of example single mode fiber (SMF), polarization-maintaining fiber (PMF), reduced cladding (RC) fiber, and multicore fiber (MCF). Further, multiple fiber types may be combined within a single FAU 202 while remaining within the scope of the present disclosure.

A number of different modes may be employed for transmitting optical signals from the optical fibers 118 through the edge-to-grating optical coupling 116. For example, in this embodiment, the optical fibers 118 are SMF, and polarization splitters 230 (corresponding to the plurality of optical fibers 118) are employed to separate modes and transmit signals to demultiplexers 232. The optical signals are then transmitted in transverse magnetic (TM) mode in the edge couplers 210 and received in transverse electrical (TE) mode in the grating couplers 208. It should be understood that this embodiment is illustrating how light of one polarization can be coupled to light of another polarization and thus the TM mode in the edge couplers 210 and TE mode in the grating couplers 208 should not be construed as limiting the scope of the present disclosure. For example, the edge couplers 210 could have TE mode and the grating couplers 208 could have TM mode, or both edge couplers 210 and grating couplers 208 could have TE mode, and combinations thereof while remaining within the scope of the present disclosure.

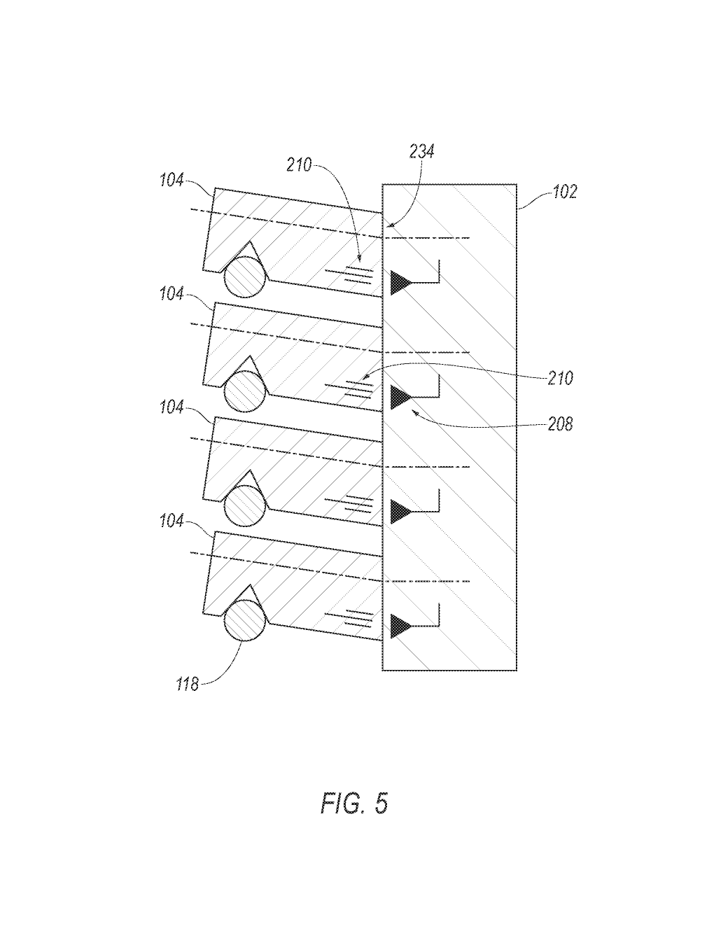

As further shown, each of the edge couplers 210 may be angled relative to the external surface 206 of the primary PIC 102 in one embodiment to provide improved coupling efficiency. The optoelectronic assembly 200 may also include an optional EIC 120 as set forth above. Optionally, and with reference to FIG. 5, rather than each of the edge couplers 210 being angled, the secondary PIC 104 is angled relative to the exterior surface of the primary PIC 102. More specifically, the secondary PIC 104 defines lower edges 234 that are angled as shown. In this embodiment, the secondary PIC 104 is angled rather than angling the edge couplers 210 to provide the improved coupling efficiency.

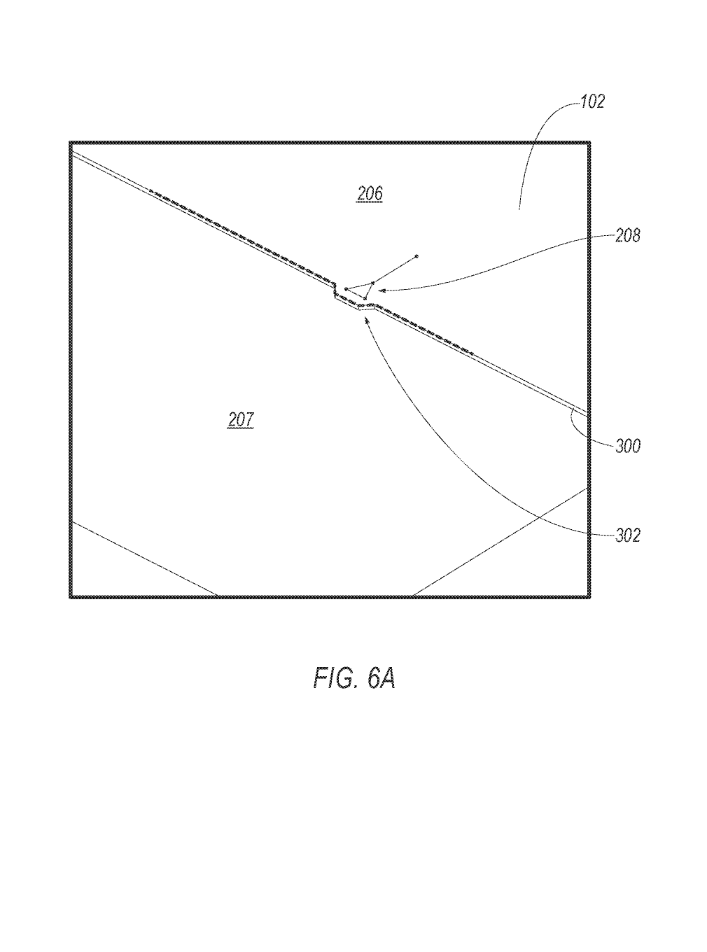

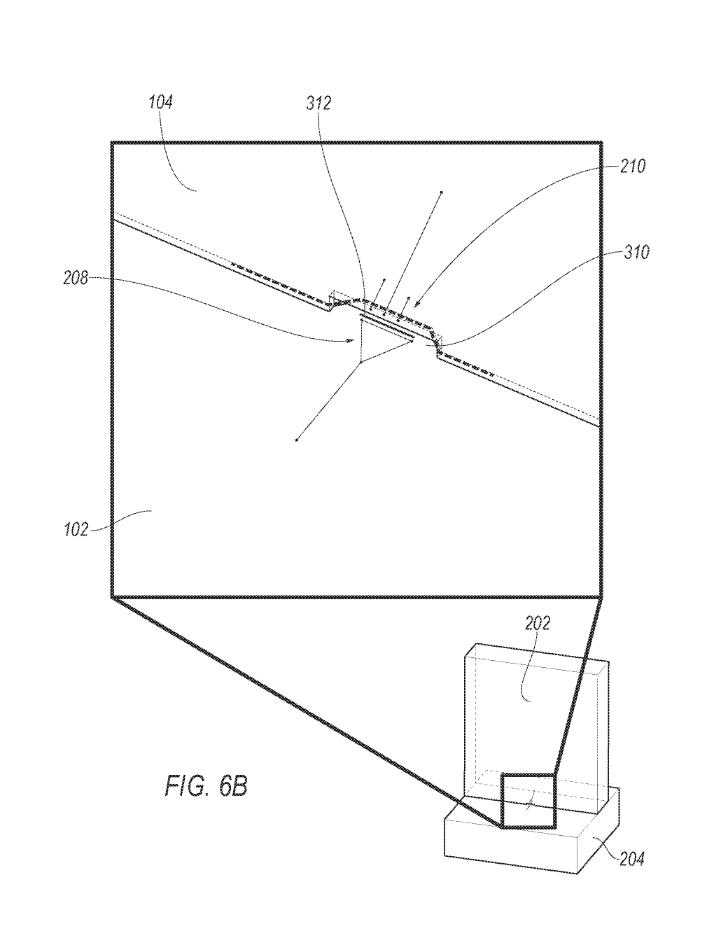

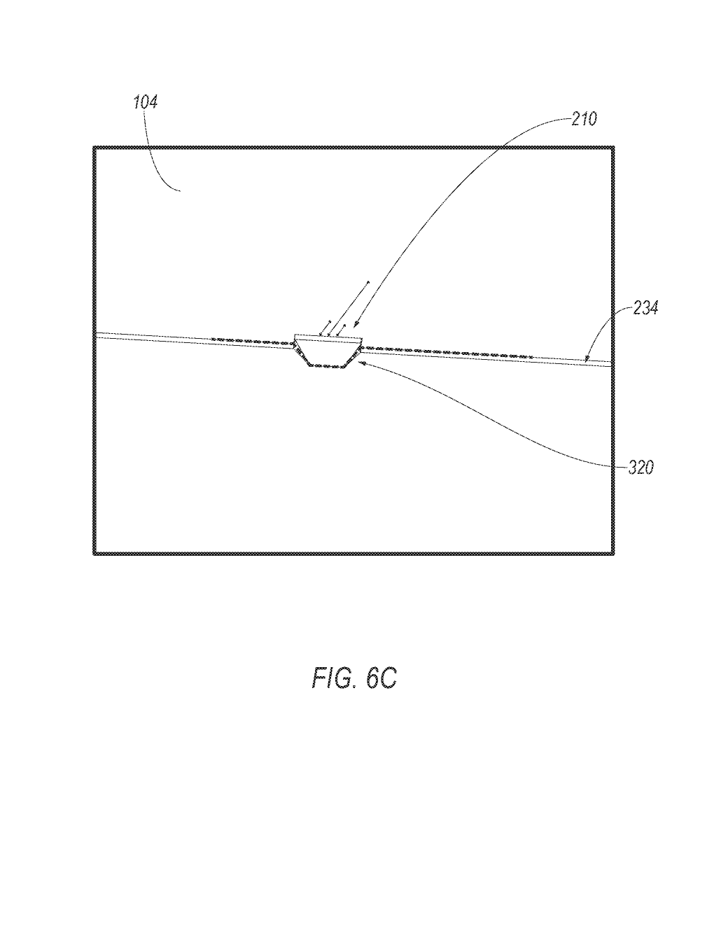

Referring now to FIGS. 6A - 6C, additional embodiments are illustrated in which each of the primary PIC 102 and the secondary PIC 104 comprise alignment features configured to align the edge couplers 210 to the grating couplers 208. In a first embodiment shown in FIG. 6A, (edge coupler 210 not shown), the exterior surface 206 of the primary PIC 102 is etched down and around each of the grating couplers 208. In this form, the exterior surface 206 is etched down to create a ledge 300 having a height of about 10 µm to about 100 µm. The ledge 300 extends down from the exterior surface 206 to an etched surface 207, and the ledge 300 also includes an extension 302 that traverses around the grating coupler 208 as shown. With this embodiment, the secondary PIC 104 (not shown), would have mating features to align with the ledge 300 and the extension 302.

As shown in FIG. 6B, another embodiment includes a protrusion 310 that extends upwardly from the exterior surface 206 of the primary PIC 102 and into the lower edge 234 of the secondary PIC 104. In this embodiment, the protrusion 310 similarly traverses above and around the grating coupler 208 and may take on any number of shapes. Thus, the edge coupler 210 is aligned to the grating coupler 208 via the protrusion 310. As further shown, an edge spot size converter (SSC) 312 is mounted to the secondary PIC 104 to reduce insertion losses due to the spacing between the edge coupler 210 and the grating coupler 208 in this embodiment.

Referring now to FIG. 6C, an arrangement to align the edge couplers 210 within the secondary PIC 104 is shown. In this form, a cavity 320 is formed into the lower edge 234 of the secondary PIC 104. The cavity 320 is generally in the shape or outline of the grating coupler 208 (not shown) so as so passively align the edge couplers 210 with the grating couplers 208. Further, each of the alignment features as disclosed herein may be formed using lithography. More specifically, the outline or perimeter of the alignment feature is formed using lithography, whereas the depth of the alignment features may be formed using various etching techniques.

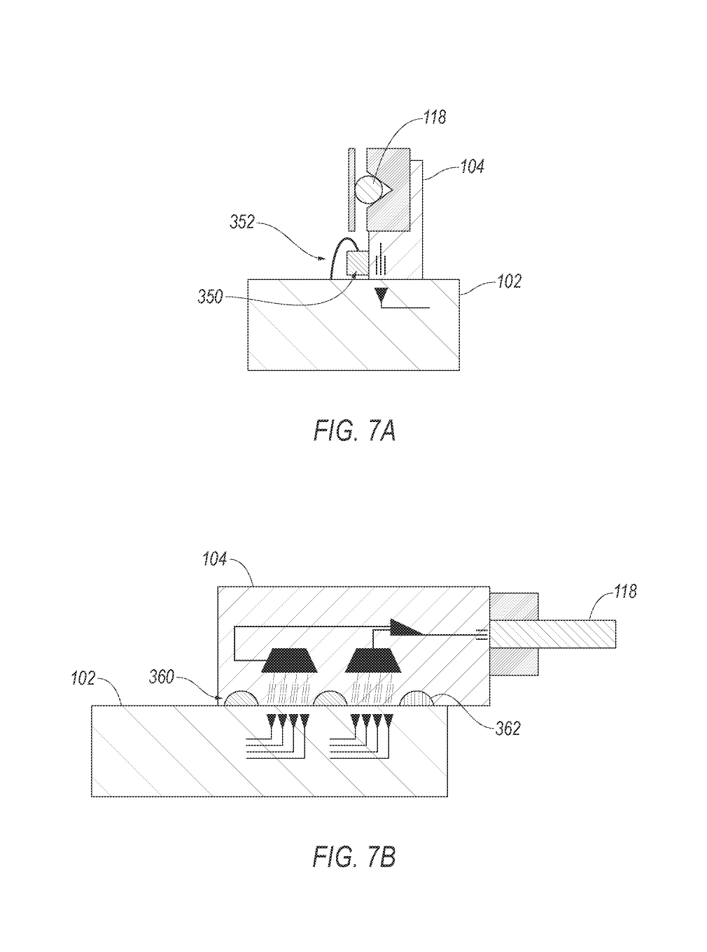

Referring now to FIGS. 7A - 7B, various approaches to electrically connect the primary PIC 102 to the secondary PIC 104 are illustrated. In FIG. 7A, the secondary PIC 104 is wire bonded to the primary PIC 102. More specifically, a metal post 350 is secured (e.g., soldering) to the secondary PIC 104 and an electrically conductive wire 352 is similarly secured to the secondary PIC 104 and the primary PIC 102. In other embodiments shown in FIG. 7B, the secondary PIC 104 is either bonded to the primary PIC 102 with a conductive epoxy 360 or with a solder 362. It should be understood that these electrical connections are merely exemplary and should not be construed as limiting the scope of the present disclosure.

The features illustrated and described herein relative to the optoelectronic assembly 200, e.g., EIC 120, polarization splitters 230, demultiplexers 232, spot size converter (SSC), among others, may be employed with the embodiment of the optoelectronic assembly 100 set forth above while remaining within the scope of the present disclosure. It should be understood that various combinations of the features illustrated and described herein may be employed while remaining within the teachings herein.

In summary, the present disclosure provides a unique and innovative edge-to-grating optical coupling that combines the individual advantages of edge couplers and grating couplers to provide more robust and lower cost optical couplings. Further, the innovative edge-to-grating optical coupling may be employed between a variety of optical components, including by way of example the primary and secondary PICs as illustrated and described herein.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An optoelectronic assembly comprising:
at least one grating coupler; and
at least one edge coupler in contact with and optically coupled to the at least one grating coupler.

2. The optoelectronic assembly of claim 1, further comprising:
a primary photonic integrated circuit (PIC) defining an exterior surface, the the least one grating coupler mounted to the exterior surface of the primary PIC; and
a secondary PIC mounted to the exterior surface of the primary PIC, the at least one edge coupler mounted to the secondary PIC.

3. The optoelectronic assembly of claim 2, wherein the at least one edge coupler is angled relative to the exterior surface of the primary PIC.

4. The optoelectronic assembly of claim 2, wherein each of the primary PIC and the secondary PIC comprise alignment features configured to align the at least one edge coupler to the at least one grating coupler.

5. The optoelectronic assembly of claim 4, wherein the alignment features are formed using lithography.

6. The optoelectronic assembly of claim 1, wherein each of the at least one grating coupler and the at least one edge coupler are configured to transmit in either transverse electrical or transverse magnetic optical modes.

7. An optoelectronic assembly comprising:
a primary photonic integrated circuit (PIC) defining an exterior surface;
at least one grating coupler mounted to the exterior surface of the primary PIC;
a secondary PIC mounted to the exterior surface of the primary PIC; and
at least one edge coupler mounted to the secondary PIC,
wherein the at least one grating coupler is in contact with and optically coupled to the at least one edge coupler.

8. The optoelectronic assembly of claim 7, wherein the at least one edge coupler is angled relative to the exterior surface of the primary PIC.

9. The optoelectronic assembly of claim 7, wherein the secondary PIC defines a lower edge angled relative to the exterior surface of the primary PIC.

10. The optoelectronic assembly of claim 7, wherein each of the primary PIC and the secondary PIC comprise alignment features configured to align the at least one edge coupler to the at least one grating coupler.

11. The optoelectronic assembly of claim 10, wherein the alignment features are formed using lithography.

12. The optoelectronic assembly of claim 7, wherein each of the at least one grating coupler and the at least one edge coupler are configured to transmit in either transverse electrical or transverse magnetic optical modes.

13. The optoelectronic assembly of claim 7, further comprising at least one electrical integrated circuit (EIC) communicatively coupled to the primary PIC or the secondary PIC.

14. An optoelectronic assembly comprising:
a primary photonic integrated circuit (PIC) defining an exterior surface;
at least one grating coupler mounted to the exterior surface of the primary PIC;
a secondary PIC mounted to the exterior surface of the primary PIC;
at least one edge coupler mounted to the secondary PIC; and
a fiber array unit (FAU) coupled to an edge of the secondary PIC,
wherein the at least one grating coupler is in contact with and optically coupled to the at least one edge coupler.

15. The optoelectronic assembly of claim 14, further comprising a plurality of optical fibers aligned within the FAU.

16. The optoelectronic assembly of claim 15, further comprising a plurality of v-grooves mounted to a side of the FAU and configured to actively align the plurality of optical fibers.

17. The optoelectronic assembly of claim 15, wherein the secondary PIC comprises a plurality of polarization splitters corresponding to the plurality of optical fibers.

18. The optoelectronic assembly of claim 15, wherein the plurality of optical fibers are different and selected from the group consisting of single mode fiber (SMF), polarization-maintaining fiber (PMF), reduced cladding (RC) fiber, and multicore fiber (MCF), and the secondary PIC comprises a plurality of polarization splitters corresponding to the plurality of optical fibers.

19. The optoelectronic assembly of claim 14, wherein the secondary PIC defines a lower edge angled relative to the exterior surface of the primary PIC.

20. The optoelectronic assembly of claim 14, wherein each of the at least one grating coupler and the at least one edge coupler are configured to transmit in either transverse electrical or transverse magnetic optical modes.
